(19) United States
(12) Patent Application Publication
(10) Pub. No.: US 2018/0045750 A1
(43) Pub. Date: Feb. 15, 2018

(54) TRANSMISSION COMPONENTS WITH A MAGNETIC COATING

(71) Applicant: GM GLOBAL TECHNOLOGY OPERATIONS LLC, DETROIT, MI (US)

(72) Inventors: Michael S McGuire, Sterling Heights, MI (US); Jonathan T Caulton, Royal Oak, MI (US)

(21) Appl. No.: 15/235,223

(22) Filed: Aug. 12, 2016

(51) Int. Cl. G01P 3/487; F16D 13/58; F16H 63/30

(52) U.S. Cl. CPC G01P 3/487; F16H 63/30; F16D 13/58; F16H 2063/3093; F16D 2300/18

(57) ABSTRACT

A transmission includes a transmission component with an integral tone wheel and a magnetic coating on the integral tone wheel.

### FIELD

The present disclosure relates to transmission components and more particularly to a transmission component including a tone wheel with a magnetic coating.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

A typical and conventional automatic transmission includes a plurality of planetary gear assemblies and friction clutch assemblies. The friction clutches include pluralities of alternating friction plates and reaction plates disposed between an inner hub with which the friction plates rotate and an outer housing with which the reaction plates rotate. When the friction plates and reaction plates are compressed, torque is transmitted between the inner hub and the outer housing.

It is frequently either desirable or necessary to sense the rotational speed of the outer housing, hub or carrier to monitor operation of the transmission and this may be achieved with a Hall effect sensor. A Hall effect sensor is a transducer that outputs a voltage in response to exposure to a magnetic field. Typically, a transmission component may include a tone wheel on the housing, and disposing a transducer proximate to the tone wheel. The tone wheel will include a plurality of teeth similar to gear teeth or a circumferential track or array of slots or openings.

The housing, hub or carrier is typically fabricated of various steels due to the strength and durability of this material. The tone wheel may also be fabricated of steel and may be a separate part secured to the housing, hub or carrier by, for example, staking, or integrally cast or formed with the housing, but in this case, not because of strength or durability but because of the properties of steel which interact with the magnetic field of the Hall effect transducer.

While various steels provide the necessary strength, durability and magnetic sensing in this service, they are not without drawbacks. The primary issue with steel components is their weight. Since these components are both carried and translated as part of the total vehicle weight and rotate and thus contribute to powertrain energy loss as they are repeatedly accelerated, they twice contribute to fuel consumption. Accordingly, any weight reduction of a rotating component, such as a clutch housing or hub, positively affects fuel consumption both from the standpoint of total weight as well as powertrain efficiency.

A solution to the weight problem is the substitution of a lighter weight material such as aluminum. Aluminum has about one-third the density of steel and exhibits good heat transfer, both characteristics being beneficial in transmission applications. However, it has been found that an aluminum housing or hub including a tone wheel is unsuitable because rotation of an aluminum tone wheel cannot be sensed by a conventional speed sensor such as, for example, a Hall effect sensor, a magnetoresistive sensor, or the like.

A solution to this problem entails fabricating the housing or hub of aluminum, the tone wheel of a magnetic material and pressing on and staking the tone wheel to the housing of the hub. The manufacture of two separate components and the assembling operation, however, renders this alternative unattractive.

### SUMMARY

A transmission includes a component with an integral tone wheel with a magnetic coating. The magnetic coating may be a magnetic tape or magnetic paint. The component may be non-ferrous and/or non-magnetic. In this manner, a separate, additional part and assembly process is obviated, thereby simplifying manufacture, reducing complexity, and reducing cost. Further, the weight of the additional part can also be avoided, which improves overall efficiency and fuel economy. Additionally, providing a magnetic coating enables the use of other types of sensors, such as, for example, a magnetoresistive sensor and does not limit the transducer to only a Hall effect type.

In another aspect, a housing for a clutch of an automatic transmission includes an annular portion having a first end and an axially separated second end, a radially extending end member merging with the second end of the annular portion, and a mounting bushing centered on the end member. The annular portion of the housing defining a plurality of circumferentially arranged and spaced apart openings and a magnetic coating on the annular portion adjacent the openings.

In another aspect, a clutch housing adapted for use in an automatic transmission includes a cylindrical portion having an outside surface, a first end and an axially spaced apart second end, and a radially extending end panel merging with the second end of the cylindrical portion and a mounting opening in the end panel. The cylindrical portion of the housing defining a plurality of circumferential, spaced apart openings and a magnetic coating on the cylindrical portion adjacent the openings.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a fragmentary sectional view of a portion of an automatic transmission including a speed sensor and an adjacent rotating component with a magnetic coating;

FIG. 2 is an enlarged fragmentary perspective view of an aluminum hub, housing or carrier including a tone wheel having a magnetic coating applied to a discontinuous surface;

FIG. 3 is a fragmentary perspective view wherein a portion of a continuous surface of a clutch hub, housing or carrier is masked prior to applying a magnetic material on a continuous surface; and

FIG. 4 is a fragmentary perspective view of an aluminum hub, housing or carrier including a tone wheel having a magnetic coating applied in discontinuous regions to a circumferential surface.

### DETAILED DESCRIPTION

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

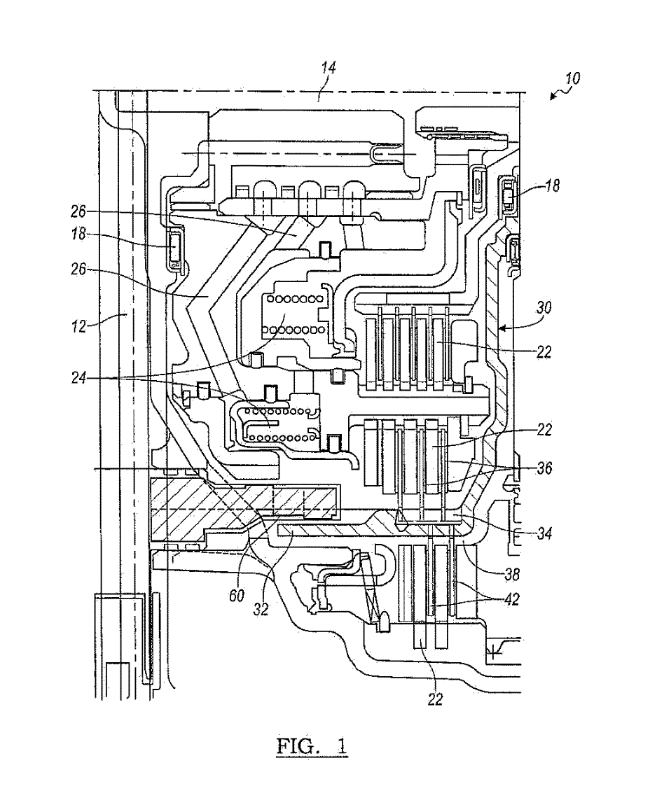

With reference to FIG. 1, a portion of a motor vehicle automatic transmission is illustrated and generally designated by the reference number 10. The automatic transmission 10 includes a housing 12 which mounts, positions and protects various components such as a plurality of shafts or quills 14, one of which is illustrated in FIG. 1, a plurality of bearings 18, a plurality of friction clutch assemblies 22, a plurality of hydraulic clutch actuator assemblies 24 and a plurality of fluid passageways 26.

Disposed between and functioning and associated with two of the friction clutch assemblies 22 is a housing, hub or carrier 30 which rotates about the axis of the shaft 14. The housing, hub or carrier 30 includes an annular or cylindrical portion 32 having interior or female splines 34 which engage friction plates 36 in one of the friction clutch 22 and exterior or male splines 38 which engage friction plates 42 in another one of the friction clutches 22.

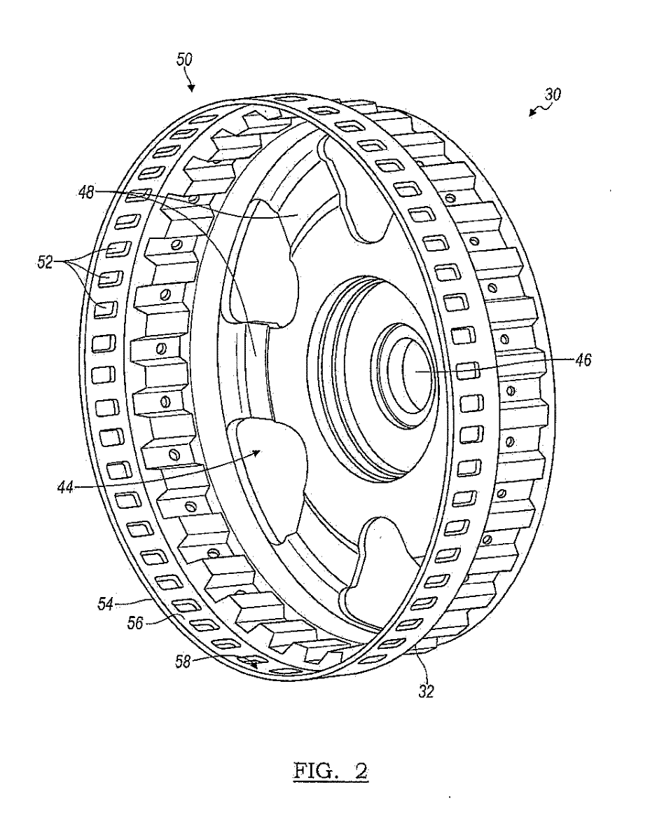

Referring now to FIGS. 1 and 2, the housing, hub or carrier 30 includes an end panel 44 which connects the annular portion 32 with a mounting bushing or bearing housing 46 which receives the shaft 14. The end panel 44 may either be solid or, in order to save weight and as illustrated in FIG. 2, include a plurality of radially extending spokes 48.

The annular portion 32 of the housing, hub or carrier 30 also includes a tone wheel 50 which defines a plurality of openings or slots 52 circumferentially disposed about and adjacent the open end edge 54 of the annular portion 32 of the housing, hub or carrier 30. Disposed in sensing relationship with the tone wheel 50 of the housing, hub or carrier is a speed sensor 60, such as a Hall effect sensor, magneto resistive sensor or the like. The output of the speed sensor 60 is provided to a transmission control module (TCM) or other similar vehicle or engine control device (not illustrated).

The housing, hub or carrier 30 is fabricated of aluminum. The interior surface 56 of the annular portion 32 of the housing, hub or carrier 30 adjacent the open end edge 54 and axially slightly beyond the openings or slots 52 is coated with a magnetic material 58, such as, for example, with a magnetic tape or magnetic paint.

Prior to coating the interior surface 56, the interior surface 56 of the annular portion 32 of the housing, hub or carrier 30 adjacent the open end edge 54 preferably undergoes treatment to provide an irregular surface finish which improves adherence of the magnetic coating 58.

The housing, hub or carrier 30 of the present invention which is fabricated of a light weight material, such as, for example, aluminum, thus provides significant weight savings which reduces both total weight and rotating (powertrain) weight while also functioning as a tone wheel with a conventional magnetic speed sensor. Additionally, the housing 30 may be fabricated as a dimensionally identical replacement so that it may be retrofit into existing apparatus and applications.

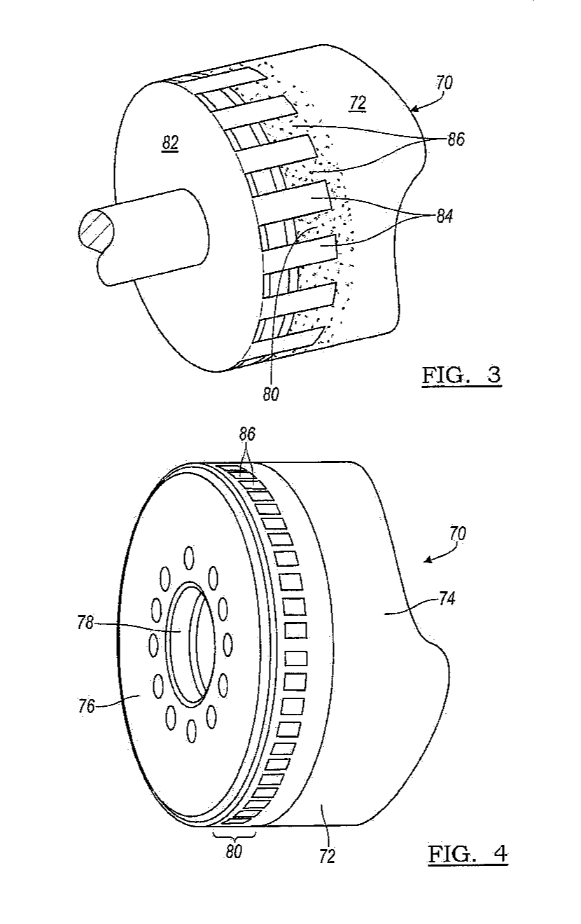

Referring now to FIGS. 3 and 4, it should be appreciated that design and engineering requirements may necessitate use of a housing, hub, carrier or similar component that cannot include conventional tone wheel openings or slots, that is, the rotating cylindrical or annular component must define a solid wall without interruptions. The annular or cylindrical component 70 illustrated in FIG. 3, which may be a housing, hub or carrier or other rotating component of an automatic transmission is so constrained and includes a solid, that is, uninterrupted, exterior cylindrical wall and surface 72. The annular or cylindrical component 70 is otherwise generally configured like the housing, hub or carrier 30, includes an open end 74, a closed end 76, with or without spokes, with a bushing or bearing mount 78 and is fabricated from a light weight material.

Prior to applying the magnetic coating 80, the exterior cylindrical surface 72 of the annular or cylindrical component 70 adjacent the open end 74 or closed end 76 preferably undergoes treatment to provide an irregular surface finish which improves adherence of the magnetic coating 80. Also, prior to applying the coating 80, a mask 82 which may be either a physical device with a plurality of teeth or fingers 84 or a chemical resist agent may be disposed adjacent the open end 74 or closed end 76 to provide a pattern of circumferentially uniform, alternating regions or patches 86 where the magnetic coating 80 will adhere and reside and where no magnetic coating 80 will be present.

Alternatively, a circumferential area or the cylindrical surface 72 or radial end face 76 of the cylindrical component 70 such as a housing, hub or carrier lacking tone wheel openings may be provided with a magnetic coating 80. The magnetic coating 80 may also be processed after applying to remove patches or regions of the magnetic coating 80.

FIG. 4 illustrates an exemplary finished product of FIG. 3 in which the annular or cylindrical component 70 fabricated of a light weight material and having a solid, that is, uninterrupted, exterior cylindrical surface 72 also includes a plurality of circumferentially spaced-apart regions or patches 86 of a magnetic coating which functions, in cooperation with a speed sensor 60 (illustrated in FIG. 1), as a tone wheel. Thus, and once again, the weight savings of a light weight material is combined in a transmission component which may be dimensionally identical with an existing part so that it may be retrofit and which includes the ability to sense rotational speed with a conventional speed sensor.

The description above is merely exemplary in nature and variations that do not depart from the gist of the invention are intended to be within the scope of the invention. Such variations are not to be regarded as a departure from the spirit and scope of the invention.

What is claimed is:

1. A transmission comprising:
a transmission component with an integral tone wheel; and
a magnetic coating on the integral tone wheel.

2. The transmission of claim 1, wherein the magnetic coating comprises a magnetic tape.

3. The transmission of claim 1, wherein the magnetic coating comprises a magnetic paint.

4. The transmission of claim 1, wherein the transmission component is non-ferrous.

5. The transmission of claim 1, wherein the transmission component is non-magnetic.

6. A housing for a clutch of an automatic transmission comprising, in combination:
an annular portion having a first end and an axially separated second end,
a radially extending end member merging with the second end of the annular portion; and
a mounting bushing centered on the end member, the annular portion of the housing defining a plurality of circumferentially arranged and spaced apart openings and a magnetic coating on the annular portion adjacent the openings.

7. The housing of claim 6, wherein the end member defines a plurality of spokes.

8. The housing of claim 6, wherein the annular portion includes an interior surface and the magnetic coating resides on the interior surface.

9. The housing of claim 6, further including a sensor in sensing relationship with the magnetically coated annular portion.

10. The housing of claim 6, further including an interior surface having female splines adapted to engage plates of a friction clutch assembly.

11. The housing of claim 6, wherein the magnetic coating comprises a magnetic tape.

12. The housing of claim 6, wherein the magnetic coating comprises a magnetic paint.

13. The housing of claim 6, wherein the housing is non-ferrous.

14. The housing of claim 6, wherein the housing is non-magnetic.

15. A clutch housing adapted for use in an automatic transmission, comprising:
a cylindrical portion having an outside surface, a first end and an axially spaced apart second end; and
a radially extending end panel merging with the second end of the cylindrical portion and a mounting opening in the end panel, the cylindrical portion of the housing defining a plurality of circumferential, spaced apart openings and a magnetic coating on the cylindrical portion adjacent the openings.

16. The clutch housing of claim 15, wherein the magnetic coating comprises a magnetic tape.

17. The clutch housing of claim 15, wherein the magnetic coating comprises a magnetic paint.

18. The clutch housing of claim 15, wherein the clutch housing is non-ferrous.

19. The clutch housing of claim 15, wherein the clutch housing is non-magnetic.
